(19) United States
(12) Patent Application Publication
(10) Pub. No.: US 2025/0222951 A1
(43) Pub. Date: Jul. 10, 2025

(54) SYSTEM AND METHOD OF AUTOMATED ONBOARDING TO VEHICLE MARSHALING SYSTEM

(71) Applicant: Ford Global Technologies, LLC, Dearborn, MI (US)

(72) Inventors: Gregory P. Linkowski, Dearborn, MI (US); Krishna Bandi, Novi, MI (US); Meghna Menon, Ann Arbor, MI (US); Mario Anthony Santillo, Canton, MI (US)

(73) Assignee: Ford Global Technologies, LLC, Dearborn, MI (US)

(21) Appl. No.: 18/405,522

(22) Filed: Jan. 5, 2024

(51) Int. Cl. B60W 60/00; B60W 50/02

(52) U.S. Cl. CPC B60W 60/001; B60W 50/0205; B60W 50/0225; B60W 2556/50; B60W 2756/10

(57) ABSTRACT

A method for marshaling an autonomously operated vehicle including the identification of the vehicle to onboard for marshaling, the transmission of location information to the vehicle from a positioning system, the transmission of one or more real-time kinematic corrections to the vehicle from a base station, and the causation of a current position of the vehicle, an orientation of the vehicle, or a combination thereof to be adjusted.

### FIELD

The present disclosure relates to onboarding one or more vehicles to a vehicle marshaling system. More specifically, the present disclosure relates to the implementation of a global positioning system and/or a global navigation satellite system in the onboarding and automated marshaling of the one or more vehicles.

### BACKGROUND

The statements in this section merely provide background information related to the present disclosure and may not constitute prior art.

The marshaling of vehicles is typically initiated by the onboarding of each vehicle to a vehicle marshaling system. However, accurately onboarding a particular vehicle among the vehicles is challenging without human intervention and is often time consuming. Onboarding of each of the vehicles also typically involves the utilization of infrastructure sensors disposed in areas along a travel route of the vehicles. In many instances, this is a solution that can be inhibiting for feasible application of such marshaling arrangements to be broadly implemented beyond a manufacturing facility, for example.

The present disclosure addresses these and other issues related to marshaling vehicles.

### SUMMARY

This section provides a general summary of the disclosure and is not a comprehensive disclosure of its full scope or all of its features.

The present disclosure provides a method for marshaling an autonomously operated vehicle, the method comprising: identifying a vehicle to onboard for marshaling; transmitting location information to the vehicle from a positioning system; and transmitting one or more positioning-related corrections to the vehicle from a base station; and causing, based on the location information and the one or more positioning-related corrections, a current position of the vehicle, an orientation of the vehicle, or a combination thereof to be adjusted; further comprising: establishing, based on the vehicle being within range of the base station, a secure data connection with the vehicle; further comprising: determining, based on identifying the vehicle, that the vehicle is within range of the base station; and onboarding, based on a secure data connection and the vehicle being within range of the base station, the vehicle; further comprising: re-onboarding, based on a disruption of the secure data connection and a positioning system associated with the base station, the vehicle; further comprising: validating, based on identifying the vehicle and the positioning system, the current position of the vehicle, wherein the positioning system is at least one of a global positioning system, a global navigation satellite system, a differential global positioning system, or a combination thereof; wherein the one or more positioning-related corrections are based on a disruption of a secure data connection with the vehicle; and wherein the one or more positioning-related corrections include real-time kinematic corrections (RTK) and are at least one of a correction of a delay in the secure data connection, a clock error, or a combination thereof.

The present disclosure provides another method for marshaling an autonomously operated vehicle, the method comprising: identifying a vehicle to onboard for marshaling; receiving, based on a secure data connection, a current position and an orientation of the vehicle; transmitting, based on the received current position and the received orientation of the vehicle, location information and one or more positioning-related corrections to the vehicle from a base station; causing, based on the location information and the one or more positioning-related corrections, the vehicle to follow a route; further comprising: establishing, based on the vehicle being within range of the base station, the secure data connection with the vehicle; further comprising: determining, based on identifying the vehicle, that the vehicle is within range of the base station; and onboarding, based on the secure data connection and the vehicle being within range of the base station, the vehicle; further comprising: re-onboarding, based on a disruption of the secure data connection and a positioning system associated with the base station, the vehicle; further comprising: validating, based on identifying the vehicle and a positioning system associated with the base station, the current position of the vehicle, wherein the positioning system is at least one of a global positioning system, a global navigation satellite system, a differential global positioning system, or a combination thereof; wherein the one or more positioning-related corrections are based on a disruption of the secure data connection with the vehicle; and wherein the one or more positioning-related corrections include RTK corrections and are at least one of a correction of a delay in the secure data connection, a clock error, or a combination thereof.

The present disclosure provides a system for guiding an autonomously operated vehicle, the marshaling system comprising: a positioning system configured to communicate with a base station and the vehicle; the base station configured to: identify a vehicle to onboard for marshaling, transmit location information to the vehicle from a positioning system, transmit one or more positioning-related corrections to the vehicle from a base station, and cause, based on the location information and the one or more positioning-related corrections, a current position of the vehicle, an orientation of the vehicle, or a combination thereof to be adjusted; and the vehicle configured to: receive the location information, receive the one or more positioning-related corrections, and adjust the current position and the orientation of the vehicle; wherein the base station is further configured to: establishing, based on the vehicle being within range of the base station, a secure data connection with the vehicle; wherein the base station is further configured to: determine, based on identifying the vehicle, that the vehicle is within range of the base station; and onboard, based on a secure data connection and the vehicle being within range of the base station, the vehicle; wherein the base station is further configured to: re-onboard, based on a disruption of the secure data connection and the positioning system associated with the base station, the vehicle; wherein the base station is further configured to: validate, based on identifying the vehicle and the positioning system associated with the base station, the current position of the vehicle, wherein the positioning system is at least one of a global positioning system, a global navigation satellite system, a differential global positioning system, or a combination thereof; and wherein the one or more positioning-related corrections are based on a disruption of a secure data connection with the vehicle, and wherein the one or more positioning-related corrections include RTK corrections and are at least one of a correction of a delay in the secure data connection, a clock error, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an overall system for an automated onboarding of a vehicle to a vehicle marshaling system;

FIG. 2 is a block diagram illustrating an example system for the automated onboarding of a vehicle to the vehicle marshaling system shown in FIG. 1;

FIG. 3 is a flowchart illustrating an example method for the automated onboarding of a vehicle to the vehicle marshaling system shown in FIG. 1;

FIG. 4 is another flowchart illustrating an example method for the automated onboarding of a vehicle to the vehicle marshaling system shown in FIG. 1;

FIG. 5 is another flowchart illustrating an example method for the automated onboarding of a vehicle to the vehicle marshaling system shown in FIG. 1; and

FIG. 6 is another flowchart illustrating an example method for the automated onboarding of a vehicle to the vehicle marshaling system shown in FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides for vehicle onboarding (i.e., pairing an established data connection with the vehicle at a given location) so that the vehicle can act upon commands issued by a control system. More specifically, in some examples, the vehicle's (e.g., a target vehicle) expected position is validated, thereby reducing any unintentional attempts at onboarding nearby vehicles relative to the location of the target vehicle. One or more examples implement a global positioning system (GPS) and/or a global navigation satellite system (GNSS) and real-time kinematic (RTK) positioning corrections for GPS/GNSS delays that obviates the need for any time consuming, tedious, and/or manual workarounds. In one or more examples, using the GPS/GNSS system combined with RTK functionality also facilitates guidance during marshaling in the case where the system temporarily may lose track of the vehicle. In this case, the vehicle can be re-onboarded, and in-place, quickly with the vehicle's precise location. As a result of onboarding and/or re-onboarding the vehicle using one or more examples described herein, less operator interaction, fewer manual interventions, and/or less restrictions on how the vehicle is introduced to the system and/or where the vehicle can be instructed to move are needed.

Additionally, with the use of the GPS/GNSS system combined with RTK functionality, sensors do not have to be positioned at frequent intervals so that constant visual of each onboarded vehicle is maintained. That is, when the visual of a vehicle is lost, the vehicle must be re-onboarded, and with one or more herein described examples implementing the GPS/GNSS system combined with RTK functionality, the requirement of using sensors in such a way is relaxed.

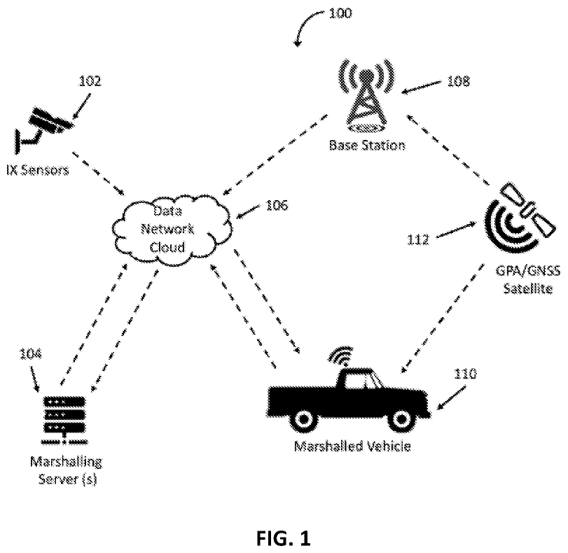

FIG. 1 shows a system 100 illustrative of a wireless communicative relationship between several entities. More specifically, the entities of the system 100 generally include one or more infrastructure sensors 102, one or more marshaling servers 104, a data network cloud 106, a base station 108, a vehicle 110, and a GPS/GNSS satellite 112.

The data network cloud 106, in various examples, is configured as the central entity of the system 100 that facilitates an exchange of data between the other entities included within the system 100. For example, the one or more infrastructure sensors 102 are disposed at varying frequencies within an infrastructure (e.g., at different locations or physical spacing in the manufacturing facility). For example, the one or more infrastructure sensors 102 may be disposed at 10-meter intervals throughout the infrastructure. The one or more infrastructure sensors 102 are configured to monitor a pathway across which the vehicle 110 may travel. The one or more infrastructure sensors 102 are also configured to send sensor data to the data network cloud 106. For example, the one or more infrastructure sensors 102 communicate sensor data to the data network cloud 106 in an instance wherein the vehicle 110 enters a field of view (e.g., within a sensing range) of any of the one or more infrastructure sensors 102.

The one or more marshaling servers 104 are configured to send one or more marshaling commands to the data network cloud 106. The one or more marshaling servers 104 are also configured to receive sensor data and/or one or more vehicle updates from the data network cloud 106. For example, the one or more vehicle updates may include odometry-related information, a pose of the vehicle, or a combination thereof. It is understood that the one or more vehicle updates may include any vehicle-related information. While a plurality of marshaling servers (e.g., the one or more marshaling servers 104) are discussed, it is understood that a single marshaling server may be implemented within the system 100.

The base station 108 is configured to communicate with both the data network cloud 106 and/or the GPS/GNSS satellite 112. The base station 108 is configured to receive GPS/GNSS positional data from the GPS/GNSS satellite 112. For example, the accuracy of the GPS/GNSS satellite 112 is dynamic, such that while a default accuracy may be within three to six meters, the GPS/GNSS satellite 112 may be even more precise. It is understood that the default accuracy of the GPS/GNSS satellite 112 may be within any range. As another example, a positional error associated with the accuracy of the GPS/GNSS satellite 112 may be introduced to the system 100 by multipath errors, clock errors, delays cause by the upper atmosphere, or a combination thereof.

The base station 108 is also configured to send one or more positioning-related corrections to the data network cloud 106. As an example, the one or more positioning-related corrections include RTK corrections. For example, the positioning-related corrections can correct for delays and/or clock issues by tracking the phase of the GPS/GNSS satellite's 112 carrier wave for precise timing and distance. As yet another example, the positioning-related corrections can correct for GPS/GNSS errors that are varyingly correlative within a geographic region, so that if the base station 108 is at a known location, the base station 108 can broadcast its calculated corrections to mobile receivers allowing for typical positional accuracy to be highly precise (e.g., one to two centimeters). However, it is understood that the positional accuracy may be within any range. Additionally, differential GPS (DGPS) can be implemented to compare measurements at one mobile GPS/GNSS receiver (e.g., a rover (not shown)), with another stationary GPS/GNSS receiver (e.g., the base station 108). While the location of the base station 108 is known, the rover positions are calculated in reference to that point with a varying level of accuracy. It is understood that the combination of the rover and the GPS/GNSS receiver may be used along with the GPS/GNSS positioning with positioning-related corrections or as an alternative to the GPS/GNSS positioning with positioning-related corrections.

The GPS/GNSS satellite 112 is configured to communicate with both the base station 108 and the vehicle 110. The GPS/GNSS satellite 112 is configured to send GPS/GNSS positional data to the base station 108. The GPS/GNSS satellite 112 is also configured to send GPS/GNSS positional data to the vehicle 110. The vehicle 110 is configured to communicate with both the GPS/GNSS satellite 112 and the data network cloud 106. The vehicle 110 is configured to receive GPS/GNSS positional data from the GPS/GNSS satellite 112. The vehicle 110 is also configured to send the one or more vehicle updates to the data network cloud 106. Additionally, the vehicle 110 is configured to receive the one or more commands and/or the positioning-related corrections from the data network cloud 106.

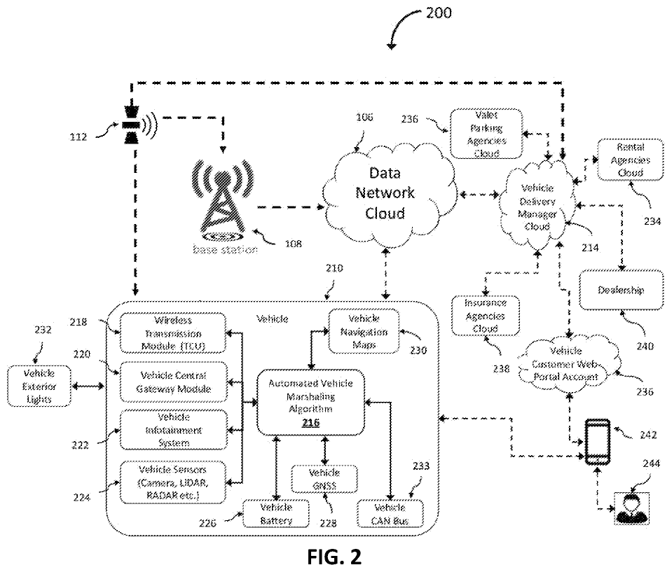

FIG. 2 shows a schematic block diagram illustration of a system 200. In one or more examples, the system 200 facilitates the marshaling of one or more vehicles traveling at a low speed. However, it is understood that the system 200 may marshal one or more vehicles traveling at any speed. It is also understood that the system 200 may marshal semi-autonomous vehicles and/or fully autonomous vehicles.

The system 200 generally includes the data network cloud 106, the base station 108, the vehicle 110, and a vehicle delivery manager cloud 214. The data network cloud 106 operates as the central component of the system 200 configured for the management and/or facilitation of a marshaling process associated with the guided transportation of the vehicle 110. For example, the vehicle 110 is configured to exchange (e.g., send and/or receive) data with the data network cloud 106.

The vehicle 110 includes or implements an automated vehicle marshaling (AVM) algorithm 216, a wireless transmission module 218, a vehicle central gateway module 220, a vehicle infotainment system 222, one or more vehicle sensors 224, a vehicle battery 226, a vehicle GNSS 228, vehicle navigation maps 230, vehicle exterior lights 232, and a controller area network (CAN) vehicle bus 233. The wireless transmission module 218 may be a transmission control unit (TCU). The wireless transmission module 218 includes one or more sensors that are configured to gather data and send signals to other components of the vehicle 110. The one or more sensors of the wireless transmission module 218 may include a vehicle speed sensor (not shown) configured to determine a current speed of the vehicle 110; a wheel speed sensor (not shown) configured to determine if the vehicle 110 is traveling at an incline or a decline; a throttle position sensor (not shown) configured to determine if a downshift or upshift of one or more gears associated with the vehicle 110 is required in a current status of the vehicle 110; and/or a turbine speed sensor (not shown) configured to send data associated with a rotational speed of a torque converter of the vehicle 110.

The wireless transmission module 218 communicates information, gathered by the one or more sensors, to the AVM algorithm 216. In one embodiment, the AVM algorithm 216 may be disposed as a component within the wireless transmission module 118. For example, the vehicle 110 utilizes the AVM algorithm 216 to process and send information gathered by the one or more sensors to the data network cloud 106. As another example, the vehicle 110 utilizes the AVM algorithm 216 to process and send information gathered by the one or more sensors to a user device 242 directly. The AVM algorithm 216 is configured to communicate information and/or instructions to the wireless transmission module 218 received from the data network cloud 106 and/or the user device 242.

The vehicle central gateway module 220 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 233. The vehicle central gateway module 220 is configured to distribute data communicated to the vehicle central gateway module 220 by each of the various domain bus systems to other components of the vehicle 110. The vehicle central gateway module 220 is also configured to distribute information received from the AVM algorithm 216 to the various domain bus systems. The vehicle central gateway module 220 is further configured to send information to the AVM algorithm 216 received from the various domain bus systems. For example, the vehicle 110 utilizes the AVM algorithm 216 to process and send information received from the vehicle central gateway module 220 to the data network cloud 106. As another example, the vehicle 110 utilizes the AVM algorithm 216 to process and send information received from the vehicle central gateway module 220 to the user device 242 directly. The AVM algorithm 216 is configured to communicate information and/or instructions to the vehicle central gateway module 220 received from the data network cloud 106 and/or the user device 242.

The vehicle infotainment system 222 is a system that delivers a combination of information and entertainment content and/or services to a user 244 of the vehicle 110. It is understood that the vehicle infotainment system 222 can deliver only entertainment content to the user 244 of the vehicle 110, in some examples. It is also understood that the vehicle infotainment system 222 can deliver information services to anyone associated with the vehicle 110, such as a passenger of the vehicle 110, for example. As an example, the vehicle infotainment system 222 includes built-in car computers that combine one or more functions, such as digital radios, built-in cameras, and/or televisions. The vehicle infotainment system 222 communicates information associated with the built-in car computers or processors to the AVM algorithm 216. For example, the vehicle 110 utilizes the AVM algorithm 216 to process and send information received from the vehicle infotainment system 222 to the data network cloud 106. As another example, the vehicle 110 utilizes the AVM algorithm 216 to process and send information received from the vehicle infotainment system 222 to the user device 242 directly. The AVM algorithm 216 is configured to communicate information and/or instructions to the vehicle infotainment system 222 received from the data network cloud 106 and/or the user device 242.

The one or more vehicle sensors 224 may be, for example, one or more of cameras, lidar, radar, and/or ultrasonic devices. For example, ultrasonic devices utilized as the one or more vehicle sensors 224 emit a high frequency sound wave that hits an object (e.g., a wall or another vehicle) and is then reflected back to the vehicle 110. Based on the amount of time it takes for the sound wave to return to the vehicle 110, the vehicle 110 can determine the distance between the one or more vehicle sensors 224 and the object. As another example, camera devices utilized as the one or more vehicle sensors 224 provide a visual indication of a space around the vehicle 110. As an additional example, radar devices utilized as the one or more vehicle sensors 224 emit electromagnetic wave signals that hit the object and is then reflected to the vehicle 110. Based on the amount of time it takes for the electromagnetic waves to return to the vehicle 110, the vehicle 110 can determine a range, velocity, and angle of the vehicle 110 relative to the object.

The one or more vehicle sensors 224 communicate information associated with the position and/or distance at which the vehicle 110 is relative to the object to the AVM algorithm 216. For example, the vehicle 110 utilizes the AVM algorithm 216 to process and send information received from the one or more vehicle sensors 224 to the data network cloud 106. As another example, the vehicle 110 utilizes the AVM algorithm 116 to process and send information received from the one or more vehicle sensors 224 to the user device 242 directly. The AVM algorithm 216 is configured to communicate information and/or instructions to the one or more vehicle sensors 224 received from the data network cloud 106 and/or the user device 242.

The vehicle battery 226 is controlled by a battery management system (not shown) that provides instructions to the vehicle battery 226. For example, the battery management system provides instructions to the vehicle battery 226 based on a temperature of the vehicle battery 226. However, it is understood that the battery management system may provide instructions to the vehicle battery 226 based on any measure associated with the vehicle battery 226. The battery management system ensures acceptable current modes of the vehicle battery 226. For example, the acceptable current modes protect against overvoltage, overcharge, and/or overheating of the vehicle battery 226. As another example, the temperature of the vehicle battery 226 indicates to the battery management system whether any of the acceptable current modes are within acceptable temperate ranges. The battery management system associated with the vehicle battery 226 communicates information associated with the temperature of the vehicle battery 226 to the AVM algorithm 216. For example, the vehicle 110 utilizes the AVM algorithm 216 to process and send information received regarding the vehicle battery 226 to the data network cloud 106. As another example, the vehicle 110 utilizes the AVM algorithm 216 to process and send information regarding the vehicle battery 226 to the user device 242 directly. The AVM algorithm 216 is configured to communicate information and/or instructions to the vehicle battery 226 received from the data network cloud 106 and/or the user device 242.

The vehicle GNSS 228 is configured to communicate with the GPS/GNSS satellite 112 so that the vehicle 110 can determine a specific location of the vehicle 110. The vehicle navigation maps 230 can display, via a display screen (not shown), the specific location of the vehicle 110 to the user 244. The vehicle GNSS 228 communicates geographical information associated with the vehicle 110 to the AVM algorithm 216. For example, the vehicle 110 utilizes the AVM algorithm 216 to process and send information received from the vehicle GNSS 228 to the data network cloud 106. As another example, the vehicle 110 utilizes the AVM algorithm 216 to process and send information from the vehicle GNSS 228 to the user device 242 directly. The AVM algorithm 216 is configured to communicate information and/or instructions to the vehicle GNSS 228 received from the data network cloud 106 and/or the user device 242. As another example, the vehicle 110 utilizes the AVM algorithm 216 to process and send information associated with the vehicle navigation maps 230 to the data network cloud 106. As another example, the vehicle 110 utilizes the AVM algorithm 216 to process and send information from the vehicle navigation maps 230 to the user device 242 directly. The AVM algorithm 216 is configured to communicate information and/or instructions to the vehicle navigation maps 230 received from the data network cloud 106 and/or the user device 242.

The vehicle exterior lights 232 can include one or more lights that are embedded around a perimeter of the vehicle 110. For example, the vehicle exterior lights 232 include, but are not limited to, low-beam headlamps, high-beam headlamps, park lights, daytime running lights, fog lights, signal lights, side marker lights, cab lights, taillights, brake lights, center mouth brake lights, and/or reverse lights. The vehicle exterior lights 232, in some examples, are configured to turn ON and OFF in a pattern to provide visual notification or information, such as an indication of one or more faults. For example, the one or more faults can be an unplanned disconnection of the vehicle 110 from the system 200 (e.g., an infrastructure (not shown) within the system 200) that may be associated with, but is not limited to, an onboarding, offboarding, and/or re-onboarding of the vehicle 110 with the infrastructure. The vehicle 110 communicates one or more instructions to the vehicle exterior lights 232 based on the AVM algorithm 216. For example, the vehicle 110 communicates one or more instructions received from the data network cloud 106 to the vehicle exterior lights 232. As another example, the vehicle 110 communicates one or more instructions received directly from the user device 242 to the vehicle exterior lights 232.

The vehicle delivery manager cloud 214 wirelessly communicates (e.g., receives and/or sends instructions and/or information) with one or more of a rental agencies cloud 234, a valet parking agencies cloud 236, an insurance agencies cloud 238, and/or a dealership 140. The vehicle delivery manager cloud 214 is configured to facilitate the delivery of the one or more vehicles to any of a rental agency (not shown) associated with the rental agencies cloud 234, a valet parking agency (not shown) associated with the valet parking agencies cloud 236, an insurance agency (not shown) associated with the insurance agencies cloud 238, and/or the dealership 240. The vehicle delivery manager cloud 214 also wirelessly communicates with a vehicle customer web-portal account accessible via the user device 242. It should be understood that other cloud systems can be included, in one or more examples.

The delivery manager cloud 214 wirelessly communicates with the user device 242 such as a mobile device, a display panel, and/or a computer. The vehicle 110 is also configured to wirelessly communicate directly with the user device 242. For example, the user 244 engages and/or interacts with the user device 242 via an application that organizes any information and/or instructions received from the vehicle customer web-portal account and/or the vehicle 110. As another example, the user 244 may send one or more instructions to the vehicle customer web-portal account such as making a selection of which vehicle the user 244 would like to receive from any of the rental agency associated with the rental agencies cloud 234, the valet parking agency associated with the valet parking agencies cloud 236, the insurance agency associated with the insurance agencies cloud 238, and/or the dealership 240.

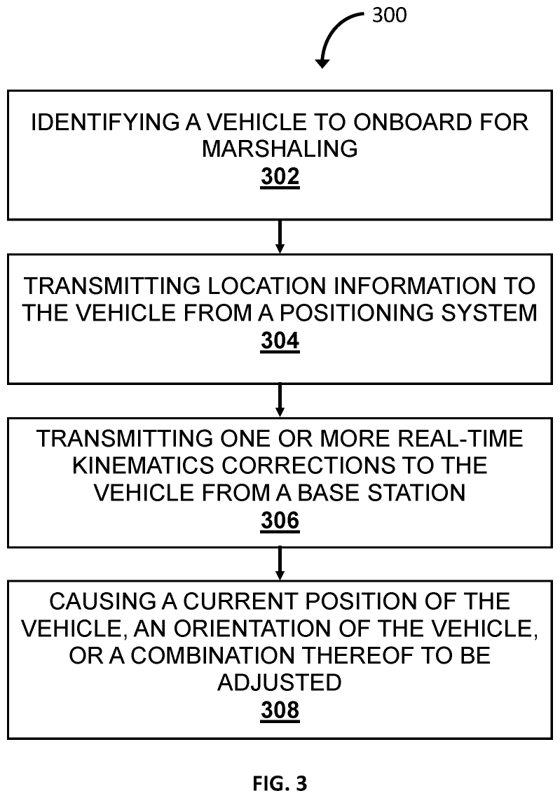

FIG. 3 is a flow chart illustrating an example method 300 for an automated onboarding of a vehicle (e.g., the vehicle 110) with a vehicle marshaling system (e.g., the systems 100 and 200) using GPS/GNSS. At operation 302, a vehicle configured to be onboarded for marshaling is identified. At operation 304, location information is transmitted to the vehicle. For example, the location information is transmitted to the vehicle from a positioning system (e.g., the GPS/GNSS satellite 112).

At operation 306, one or more positioning-related corrections are transmitted to the vehicle. For example, the one or more positioning-related corrections are transmitted to the vehicle from a base station (e.g., the base station 108). As another example, the positioning-related corrections are based on a disruption of a secure data connection with the vehicle. As an additional example, the positioning-related corrections include RTK corrections, and/or wherein the one or more positioning-related corrections are at least one of a correction of a delay in the secure data connection, a clock error, or a combination thereof. In an embodiment, at operation 308, a current position of the vehicle is caused to be adjusted. In another embodiment, at operation 308, an orientation of the vehicle is caused to be adjusted. In a further embodiment, at operation 308, a combination of the current position of the vehicle and the orientation of the vehicle is caused to be adjusted. In yet another embodiment, at operation 308, the current position of the vehicle, the orientation of the vehicle, or the combination thereof is adjusted based on the location information and/or the one or more positioning-related corrections.

In one embodiment, a determination of whether the vehicle is within range of the base station is made. For example, the determination of whether the vehicle is within range of the base station is made based on the identification of the vehicle. In an instance wherein the vehicle is within range of the base station, the vehicle is onboarded. For example, based on the secure data connection and in the instance wherein the vehicle is within range of the base station, the vehicle is onboarded.

In another embodiment, in an instance wherein a disruption of the secure data connection occurs, the vehicle is re-onboarded. For example, the re-onboarding of the vehicle is based on a disruption of the secure data connection and a positioning system associated with the base station. In yet another embodiment, the current position of the vehicle is validated. For example, the current position of the vehicle is validated based on identification of the vehicle and/or the positioning system. As another example, the positioning system is at least one of a global positioning system, a global navigation satellite system, a differential global positioning system, or a combination thereof.

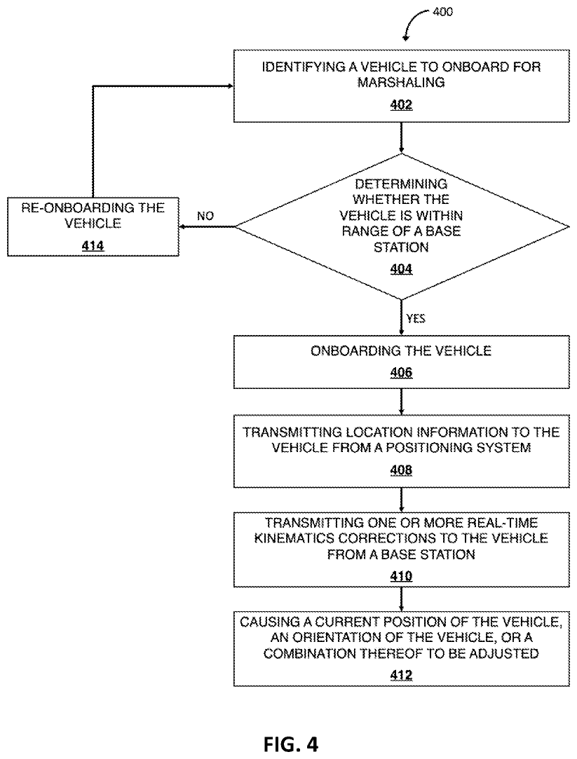

FIG. 4 is a flow chart illustrating an example method 400 for an automated onboarding of a vehicle (e.g., the vehicle 110) to a vehicle marshaling system (e.g., the systems 100 and 200) using GPS/GNSS. At operation 402, a vehicle configured to be onboarded for marshaling is identified. At step 404, a determination is made regarding whether the vehicle is within range of a base station (e.g., the base station 108). In an instance wherein the vehicle is determined to be within range of the base station, the vehicle is onboarded at operation 406. For example, the vehicle is onboarded based on a secure data connection.

At step 408, location information is transmitted. For example, the location information is transmitted to the vehicle from a positioning system (e.g., the GPS/GNSS satellite 112). At step 410, one or more positioning-related corrections are transmitted. For example, the positioning-related corrections are transmitted to the vehicle from the base station. As another example, the positioning-related corrections are based on a disruption of a secure data connection with the vehicle. As an additional example, the positioning-related corrections include RTK corrections, and/or wherein the one or more positioning-related corrections are at least one of a correction of a delay in the secure data connection, a clock error, or a combination thereof.

In one embodiment, at operation 412, a current position of the vehicle is caused to be adjusted. In another embodiment, at operation 412, an orientation of the vehicle is caused to be adjusted. In a further embodiment, at operation 412, a combination of the current position of the vehicle and the orientation of the vehicle is caused to be adjusted. In yet another embodiment, at operation 412, the current position of the vehicle, the orientation of the vehicle, or the combination thereof is adjusted based on the location information and/or the one or more positioning-related corrections. However, in a case wherein the vehicle is determined to not be within range of the base station, the vehicle is re-onboarded at operation 414. For example, the re-onboarding of the vehicle is based on a disruption of the secure data connection and a positioning system associated with the base station.

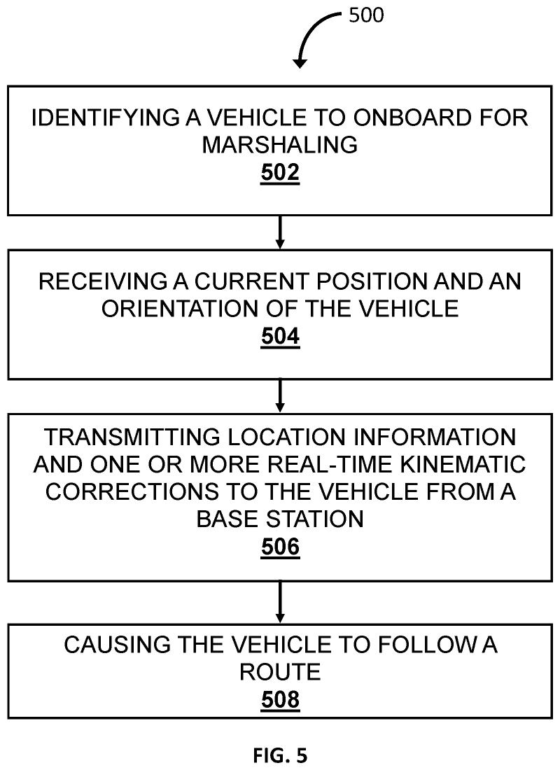

FIG. 5 is another flow chart illustrating an example method 500 for an automated onboarding of a vehicle (e.g., the vehicle 110) to a vehicle marshaling system (e.g., the systems 100 and 200) using GPS/GNSS. At operation 502, a vehicle configured to be onboarded for marshaling is identified. At operation 504, a current position and/or an orientation of the vehicle is received. For example, the current position and/or the orientation of the vehicle is received based on a secure data connection.

At operation 506, location information and/or one or more positioning-related corrections are transmitted. For example, the location information and/or the one or more positioning-related corrections are transmitted to the vehicle from a base station (e.g., the base station 108). As another example, the transmission of the location information and/or the one or more positioning-related corrections are based on the received current position and/or the received orientation of the vehicle. As an additional example, the positioning-related corrections are based on a disruption of the secure data connection with the vehicle. As a further example, the positioning-related corrections include RTK corrections, and/or wherein the one or more positioning-related corrections are at least one of a correction of a delay in the secure data connection, a clock error, or a combination thereof. At operation 508, the vehicle is caused to follow a route. For example, the vehicle is caused to follow the route based on the location information and/or the one or more positioning-related corrections.

In one embodiment, the secure data connection with the vehicle is established. For example, the establishment of the secure data connection is based on the vehicle being within range of the base station. In another embodiment, a determination of whether the vehicle is within range of the base station is made. For example, the determination of whether the vehicle is within range of the base station is made based on identifying the vehicle. In an instance wherein the vehicle is within range of the base station, the vehicle is onboarded. For example, based on the secure data connection and in the instance wherein the vehicle is within range of the base station, the vehicle is onboarded.

In another embodiment, in an instance wherein a disruption of the secure data connection occurs, the vehicle is re-onboarded. For example, the re-onboarding of the vehicle is based on a disruption of the secure data connection and a positioning system associated with the base station. In yet another embodiment, the current position of the vehicle is validated. For example, the current position of the vehicle is validated based on identification of the vehicle and/or the positioning system. As an example, the positioning system is associated with the base station. As another example, the positioning system is at least one of a global positioning system, a global navigation satellite system, a differential global positioning system, or a combination thereof.

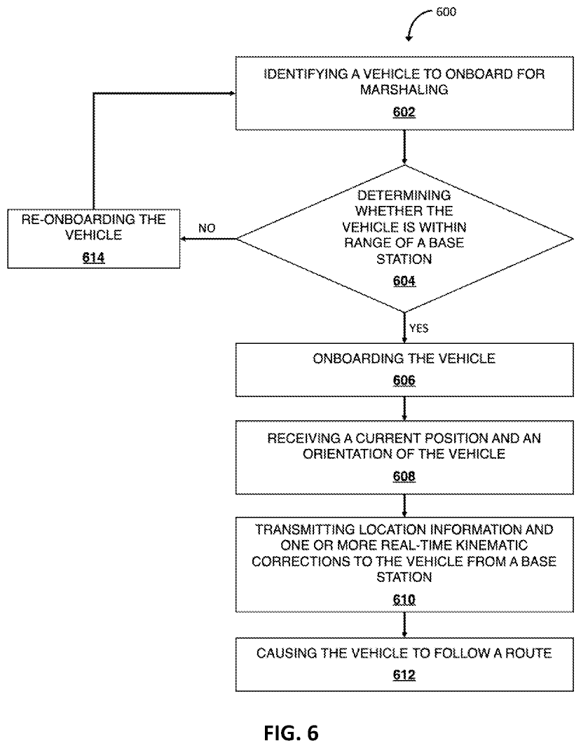

FIG. 6 is a flow chart illustrating an example method 600 for an automated onboarding of a vehicle (e.g., the vehicle 110) to a vehicle marshaling system (e.g., the systems 100 and 200) using GPS/GNSS. At operation 602, a vehicle configured to be onboarded for marshaling is identified. At step 604, a determination is made regarding whether the vehicle is within range of a base station (e.g., the base station 108). In an instance wherein the vehicle is determined to be within range of the base station, the vehicle is onboarded at operation 606. For example, the vehicle is onboarded based on a secure data connection.

At operation 608, a current position and/or an orientation of the vehicle is received. For example, the current position and/or the orientation of the vehicle is received based on a secure data connection. At operation 610, location information and/or one or more positioning-related corrections are transmitted. For example, the location information and/or the one or more positioning-related corrections are transmitted to the vehicle from the base station. As another example, the transmission of the location information and/or the one or more positioning-related corrections are based on the received current position and/or the received orientation of the vehicle. As an additional example, the positioning-related corrections are based on a disruption of the secure data connection with the vehicle. As a further example, the positioning-related corrections include RTK corrections, and/or wherein the one or more positioning-related corrections are at least one of a correction of a delay in the secure data connection, a clock error, or a combination thereof. For example, the vehicle is caused to follow the route based on the location information and/or the one or more positioning-related corrections. However, in a case wherein the vehicle is determined to not be within range of the base station, the vehicle is re-onboarded at operation 614. For example, the re-onboarding of the vehicle is based on a disruption of the secure data connection and a positioning system associated with the base station.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for marshaling an autonomously operated vehicle, the method comprising:
identifying a vehicle to onboard for marshaling;
transmitting location information to the vehicle from a positioning system;
transmitting one or more positioning-related corrections to the vehicle from a base station; and
causing, based on the location information and the one or more positioning-related corrections, a current position of the vehicle, an orientation of the vehicle, or a combination thereof to be adjusted.

2. The method of claim 1, further comprising:
establishing, based on the vehicle being within range of the base station, a secure data connection with the vehicle.

3. The method of claim 1, further comprising:
determining, based on identifying the vehicle, that the vehicle is within range of the base station; and
onboarding, based on a secure data connection and the vehicle being within range of the base station, the vehicle.

4. The method of claim 3, further comprising:
re-onboarding, based on a disruption of the secure data connection and a positioning system associated with the base station, the vehicle.

5. The method of claim 1, further comprising:
validating, based on identifying the vehicle and the positioning system, the current position of the vehicle, wherein the positioning system is at least one of a global positioning system, a global navigation satellite system, a differential global positioning system, or a combination thereof.

6. The method of claim 2, wherein the one or more positioning-related corrections are based on a disruption of a secure data connection with the vehicle.

7. The method of claim 6, wherein the one or more positioning-related corrections include real-time kinematic corrections and are at least one of a correction of a delay in the secure data connection, a clock error, or a combination thereof.

8. A method for marshaling an autonomously operated vehicle, the method comprising:
identifying a vehicle to onboard for marshaling;
receiving, based on a secure data connection, a current position and an orientation of the vehicle;
transmitting, based on the received current position and the received orientation of the vehicle, location information and one or more positioning-related corrections to the vehicle from a base station; and
causing, based on the location information and the one or more positioning-related corrections, the vehicle to follow a route.

9. The method of claim 8, further comprising:
establishing, based on the vehicle being within range of the base station, the secure data connection with the vehicle.

10. The method of claim 8, further comprising:
determining, based on identifying the vehicle, that the vehicle is within range of the base station; and
onboarding, based on the secure data connection and the vehicle being within range of the base station, the vehicle.

11. The method of claim 10, further comprising:
re-onboarding, based on a disruption of the secure data connection and a positioning system associated with the base station, the vehicle.

12. The method of claim 8, further comprising:
validating, based on identifying the vehicle and a positioning system associated with the base station, the current position of the vehicle, wherein the positioning system is at least one of a global positioning system, a global navigation satellite system, a differential global positioning system, or a combination thereof.

13. The method of claim 8, wherein the one or more positioning-related corrections are based on a disruption of the secure data connection with the vehicle.

14. The method of claim 13, wherein the one or more positioning-related corrections include real-time kinematic corrections and are at least one of a correction of a delay in the secure data connection, a clock error, or a combination thereof.

15. A marshaling system for guiding an autonomously operated vehicle, the marshaling system comprising:
a positioning system configured to communicate with a base station and the vehicle;
the base station configured to:
identify a vehicle to onboard for marshaling,
transmit location information to the vehicle from a positioning system,
transmit one or more positioning-related corrections to the vehicle from a base station, and
cause, based on the location information and the one or more positioning-related corrections, a current position of the vehicle, an orientation of the vehicle, or a combination thereof to be adjusted; and
the vehicle configured to:
receive the location information,
receive the one or more positioning-related corrections, and
adjust the current position and the orientation of the vehicle.

16. The marshaling system of claim 15, wherein the base station is further configured to:
establish, based on the vehicle being within range of the base station, a secure data connection with the vehicle.

17. The marshaling system of claim 15, wherein the base station is further configured to:
determine, based on identifying the vehicle, that the vehicle is within range of the base station; and
onboard, based on a secure data connection and the vehicle being within range of the base station, the vehicle.

18. The marshaling system of claim 16, wherein the base station is further configured to:
re-onboard, based on a disruption of the secure data connection and the positioning system associated with the base station, the vehicle.

19. The marshaling system of claim 15, wherein the base station is further configured to:
validate, based on identifying the vehicle and the positioning system associated with the base station, the current position of the vehicle, wherein the positioning system is at least one of a global positioning system, a global navigation satellite system, a differential global positioning system, or a combination thereof.

20. The marshaling system of claim 15, wherein the one or more positioning-related corrections are based on a disruption of a secure data connection with the vehicle, and wherein the one or more positioning-related corrections include real-time kinematic corrections and are at least one of a correction of a delay in the secure data connection, a clock error, or a combination thereof.
